(19) United States
(12) Patent Application Publication
(10) Pub. No.: US 2015/0008631 A1
(43) Pub. Date: Jan. 8, 2015

(54) SPRING CLAMP

(71) Applicant: Sung-Chi Liu, Taichung City (TW)

(72) Inventor: Sung-Chi Liu, Taichung City (TW)

(21) Appl. No.: 14/286,928

(22) Filed: May 23, 2014

(30) Foreign Application Priority Data
Jul. 4, 2013 (TW) 102212682

(51) Int. Cl. B25B 5/04; B25B 5/16

(52) U.S. Cl. CPC B25B 5/04; B25B 5/166; B25B 5/16
USPC 269/164

(57) ABSTRACT

A spring clamp may include a main body, two clamping units, a plurality of positioning pins and a positioning unit, wherein a main body has two clamping arms pivotally connected together in a cross manner, and one end of each clamping arms has a handle and the positioning unit is disposed between the handles; the other end of each clamping arms has a socket that is not aligned with each other; and wherein each of the clamping units has a clamping piece connected with an extension bar that is inserted into the socket of the main body, so a clamp opening becomes adjustable through extension and retraction of the extension bar, and two positioning pins on the clamping arms are used to secure the extension bars, and the positioning pins located in an opposite direction to a direction of the pressure applied on the extension bar.

### FIELD OF THE INVENTION

This invention is related to a spring clamp, and more particularly to a spring clamp having a simple structure and an adjustable clamp opening.

### BACKGROUND OF THE INVENTION

A conventional spring clamp can be used to hold pieces or parts together. Usually, the clamp openings are fixed for most of the spring clamps, so two or more spring clamps of different sizes may be necessary for holding parts of different sizes, which leads to the increase of manufacture costs and requires a lot of storage spaces. Therefore, there remains a need for a new and improved spring clamp to overcome the problems stated above.

### SUMMARY OF THE INVENTION

Usually, the clamp openings of conventional spring clamps are fixed for most of the spring clamps, so two or more spring clamps of different sizes may be necessary for holding parts of different sizes, which leads to the increase of manufacture costs and requires a lot of storage spaces.

To solve the problem stated above, the present invention provides a spring clamp may include a main body, two clamping units, a plurality of positioning pins and a positioning unit. The main body has two clamping arms pivotally connected together in a cross manner. One end of each clamping arms has a handle and a spring is disposed between the two handles. The other end of each clamping arms has a socket that is not aligned with each other. Each clamping unit has a clamping piece connected with an extension bar that is inserted into the socket of the main body, so a clamp opening becomes adjustable through the extension and retraction of the extension bar. Two positioning pins on the clamping arms are used to secure the extension bars, and the positioning pins are located in the opposite direction to the direction of the pressure applied on the extension bar. The positioning unit, which includes a shaft, a base, a lever and a compression spring, is disposed diagonally between the two handles.

Comparing with conventional arts, the present invention is advantageous because (i) the clamp opening can be adjusted through the extension and retraction of the extension bars, the socket and the positioning pins, so the spring clamp can be used to hold multiple objects of different sizes to save the manufacturing cost as well as the storage spaces; and (ii) the spring clamp has a simple structure and is easy to use.

### BRIEF DESCRIPTION OF THE DRAWINGS

FIG. 1 illustrates a two-dimensional view of the present invention.

FIG. 2 illustrates a three-dimensional exploded view of the present invention.

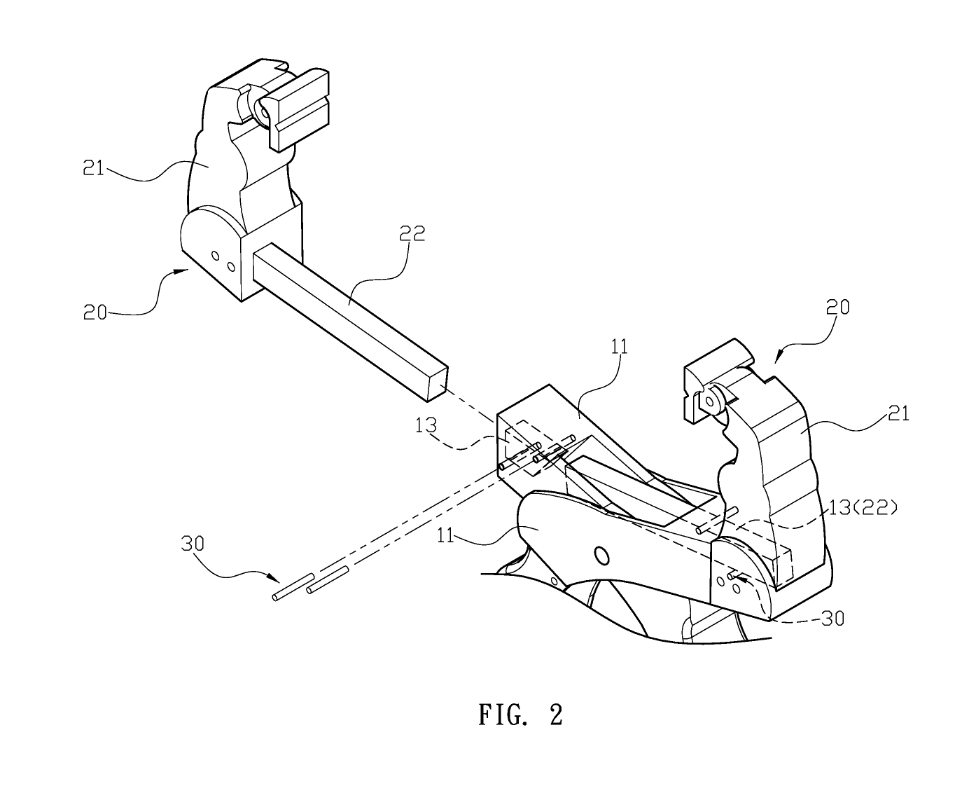

FIG. 3 illustrates a schematic view of the spring clamp in the present invention when it is tightened.

FIG. 4 illustrates a schematic view of the spring clamp in the present invention when it is being adjusted.

FIG. 5 illustrates a schematic view of the spring clamp in the present invention when it is tightened after being adjusted.

FIG. 6 illustrates a force diagram of the spring clamp in the present invention.

FIG. 7 illustrates another embodiment in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

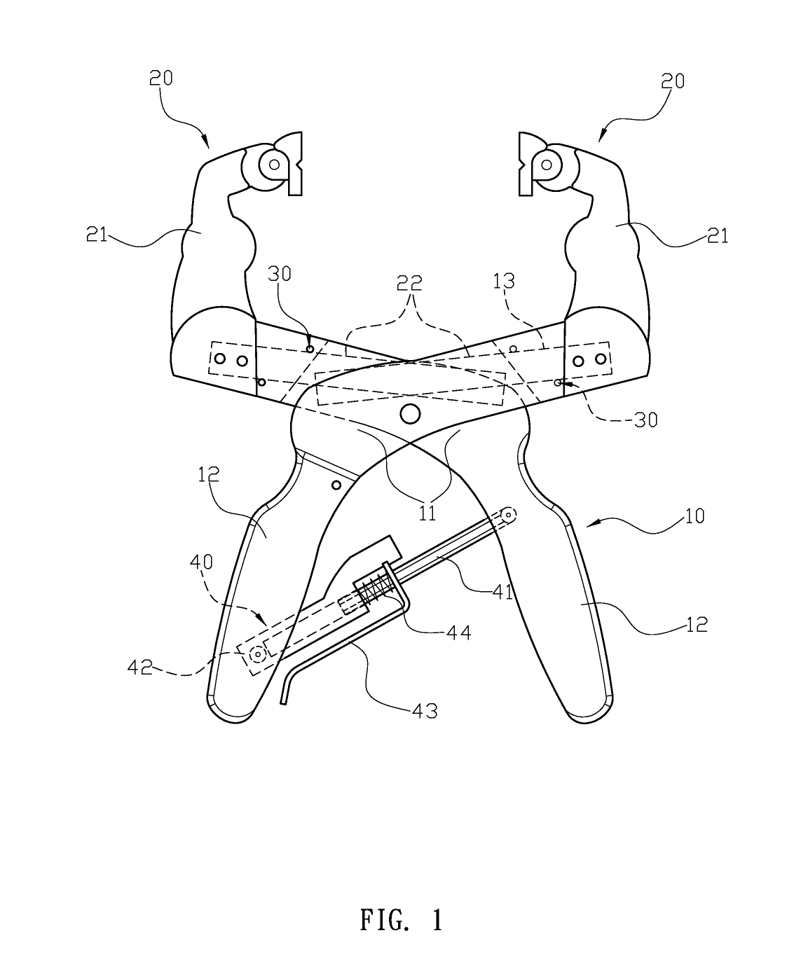

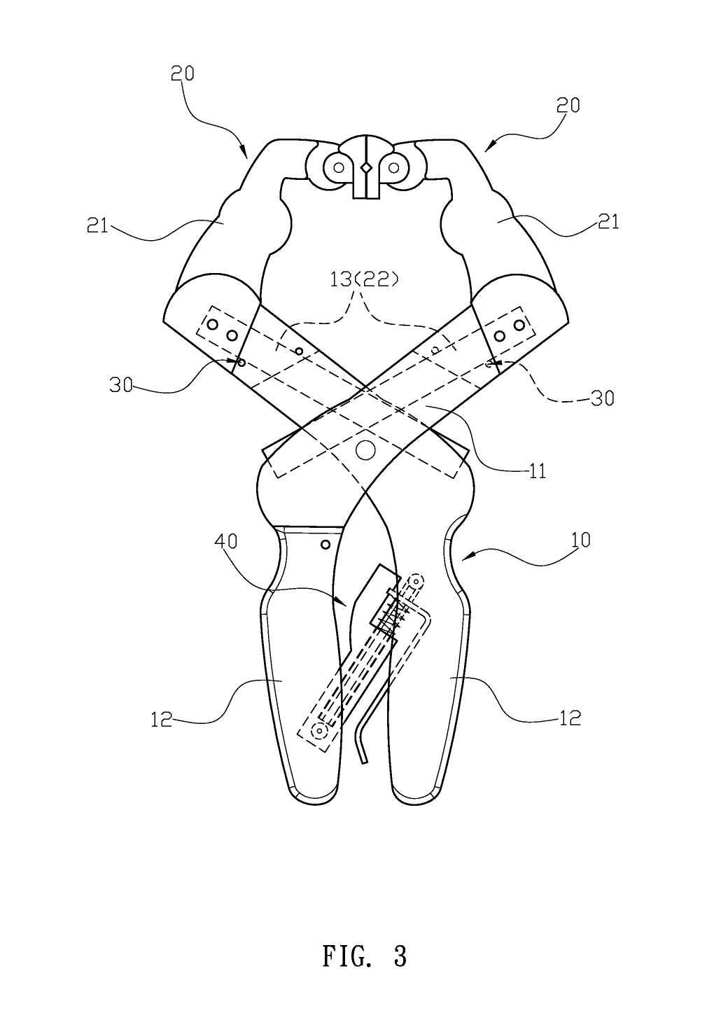

As shown in FIG. 1 and FIG. 3, a spring clamp may include a main body (10), two clamping units (20), a plurality of positioning pins (30) and a positioning unit (40). The main body (10) has two clamping arms (11) pivotally connected together in a cross manner. One end of each clamping arms (11) has a handle (12) and a first spring is disposed between the two handles (12). The other end of each clamping arms (11) has a socket (13) that is not aligned with each other. Each clamping unit (20) has a clamping piece (21) connected with an extension bar (22) that is inserted into the socket (13) of the main body (10), so a clamp opening becomes adjustable through the extension and retraction of the extension bar (22). Two positioning pins (30) on the clamping arms (11) are used to secure the extension bars (22), and the positioning pins are located in the opposite direction to the direction of the pressure applied on the extension bar (22). The positioning unit (40), which includes a shaft (41), a base (42), a lever (43) and a compression spring (44), is disposed diagonally between the two handles (12).

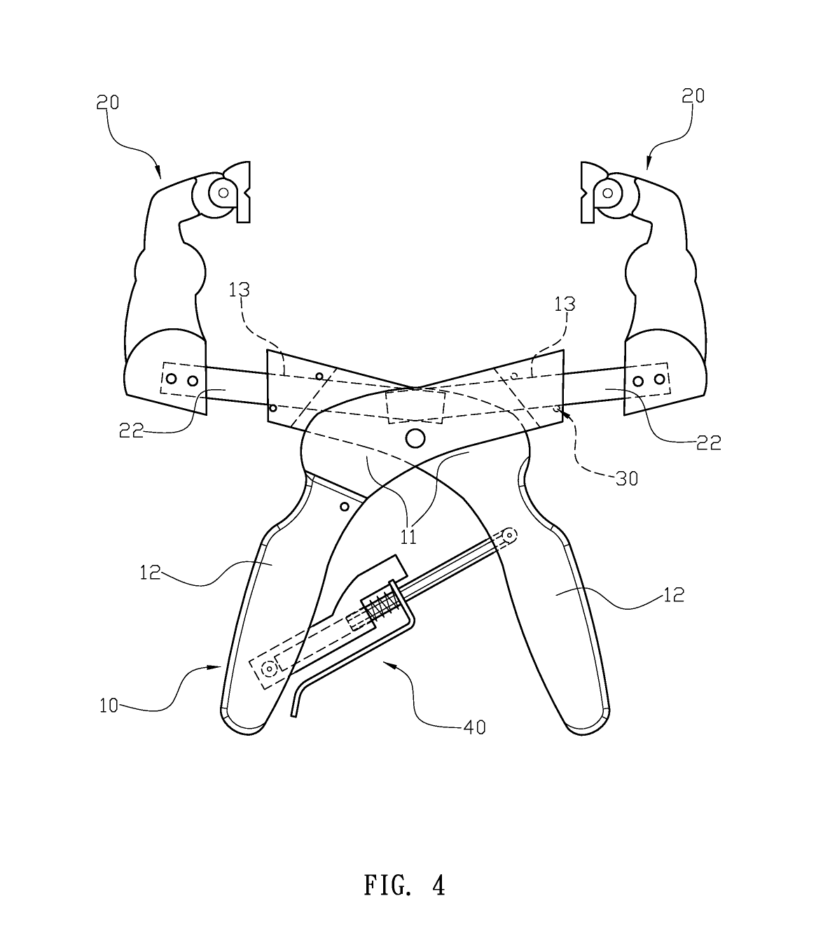

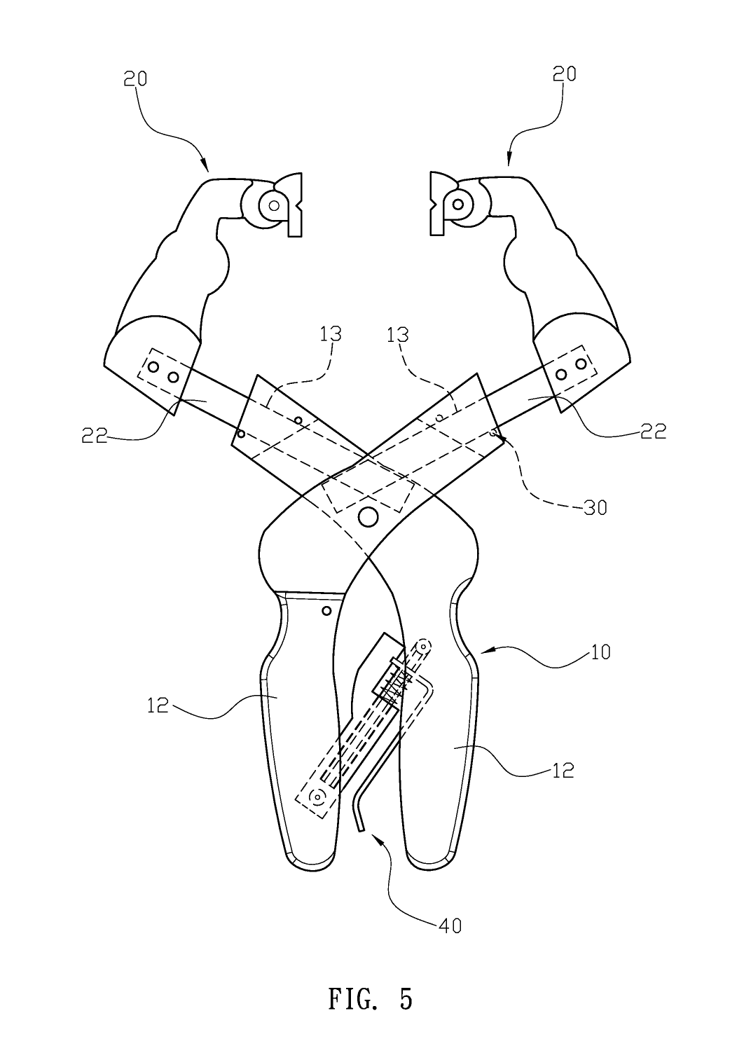

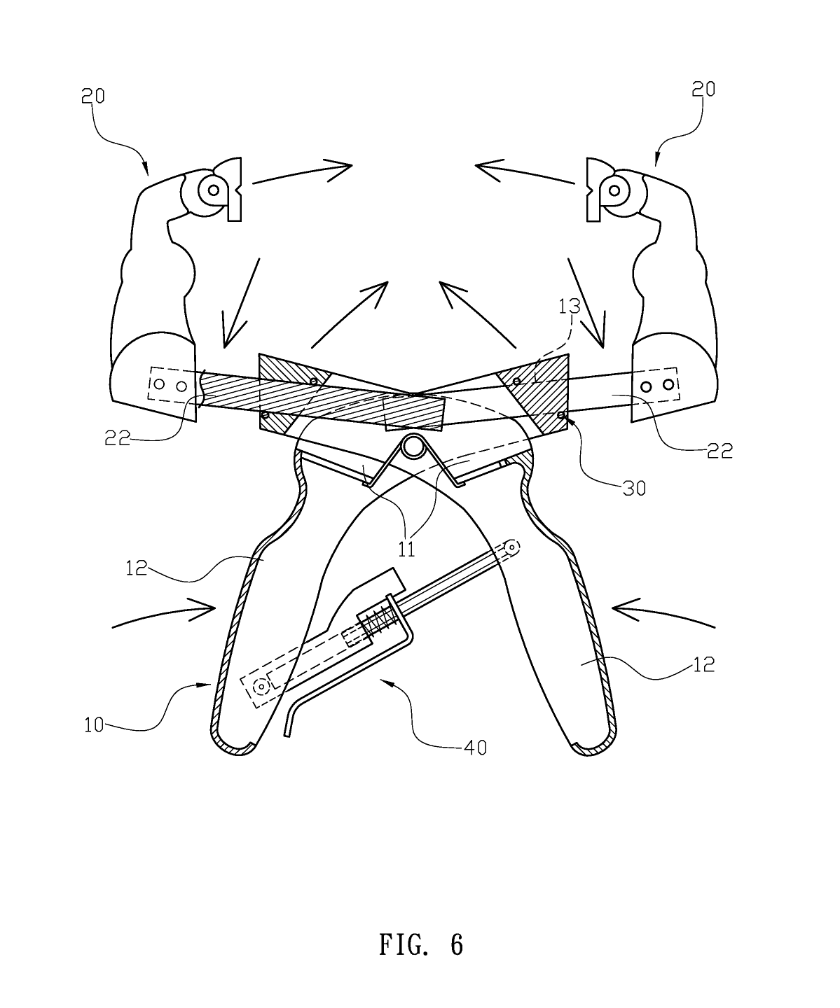

As shown in FIGS. 4 and 5, the clamp opening can be adjusted by the extension and retraction of the extension bar (22). When a user squeezes the handles (12) to hold an object with the clamping units (20), the squeezing pressure causes the positioning pins (30) to further secure the position of the extension bars (22) and the object can thus be tightly held (see FIG. 6).

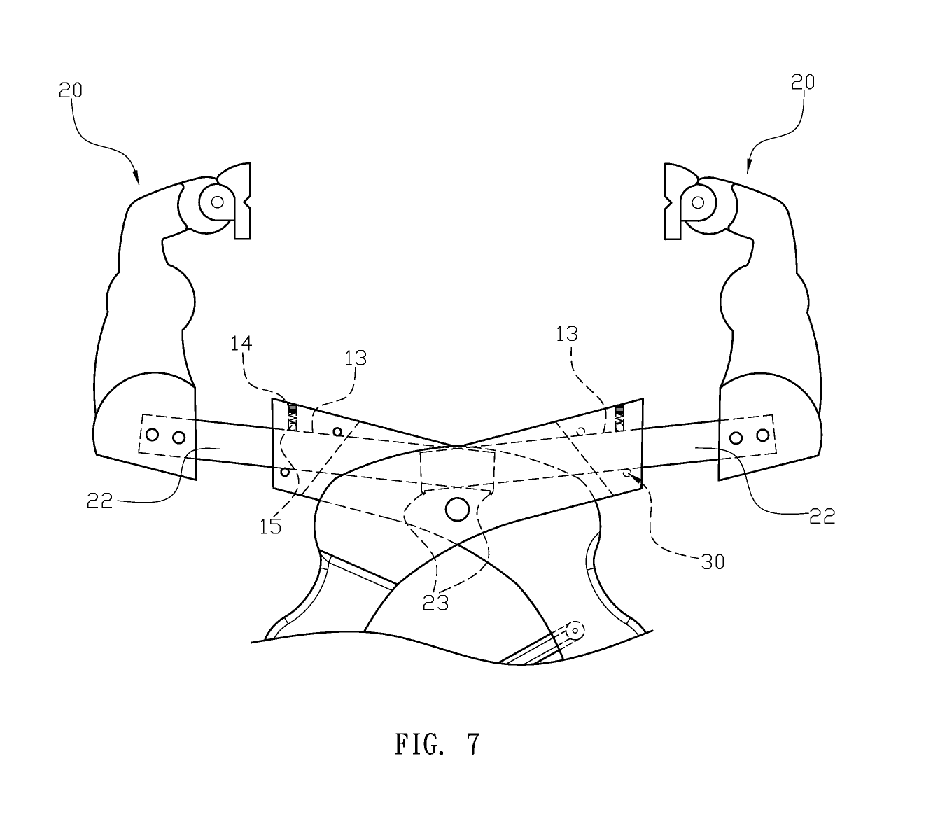

As shown in FIG. 7, there is a second spring (14) pushing a stopper (15) or a pin against the extension bar (22) near each socket (13). Each extension bar (22) has a stopping block (23) at a rear end, which works together with the positioning pin (30) to keep the extension bar (22) from falling out from the socket (13).

According to the embodiments discussed above, the present invention is advantageous because (i) the clamp opening can be adjusted through the extension and retraction of the extension bars (22), the socket (13) and the positioning pins (30), so the spring clamp can be used to hold multiple objects of different sizes to save the manufacturing cost as well as the storage spaces; and (ii) the spring clamp has a simple structure and is easy to use.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A spring clamp comprising a main body, two clamping units, a plurality of positioning pins and a positioning unit,
wherein a main body has two clamping arms pivotally connected together in a cross manner, and one end of each clamping arms has a handle and the positioning unit is disposed between the handles; the other end of each clamping arms has a socket that is not aligned with each other;
wherein each of the clamping units has a clamping piece connected with an extension bar that is inserted into the socket of the main body, so a clamp opening becomes adjustable through extension and retraction of the extension bar, and two positioning pins on the clamping arms are used to secure the extension bars, and the positioning pins located in an opposite direction to a direction of the pressure applied on the extension bar.

2. The spring clamp of claim 1, wherein a first spring is disposed between said two handles.

3. The spring clamp of claim 1, wherein the positioning unit is diagonally disposed between said two handles.

4. The spring clamp of claim 1, wherein the positioning unit has a shaft, a base, a lever and a compression spring.

5. The spring clamp of claim 3, wherein the positioning unit has a shaft, a base, a lever and a compression spring.

6. The spring clamp of claim 1, wherein a stopper is pushed by a second spring against the extension bar near each socket.

7. The spring clamp of claim 1, wherein each extension bar has a stopping block at a rear end thereof, which works together with the positioning pin to keep the extension bar from falling out from the socket.
